(19) United States
(12) Patent Application Publication
(10) Pub. No.: US 2005/0055463 A1
(43) Pub. Date: Mar. 10, 2005

(54) Secure internet functionality

(75) Inventors: Anne E. Saunders, Orinda, CA (US); Andreas Schmidt, Oakland, CA (US)

Correspondence Address: PATENT LAW GROUP LLP, 2635 NORTH FIRST STREET, SUITE 223, SAN JOSE, CA, 95134, US

(73) Assignee: VeriLegal, Inc.

(21) Appl. No.: 10/841,624

(22) Filed: May 7, 2004

Related U.S. Application Data
(60) Provisional application No. 60/471,041, filed on May 16, 2003.

(51) Int. Cl. G06F 15/16

(52) U.S. Cl. 709/246; 713/200

(57) ABSTRACT

A method to send data from a client application on a client device to a server application over a network includes listening for an outgoing request from the client application to a first socket in the client device. The method further includes, in response to hearing the outgoing request, retrieving a routing table based on the first socket, establishing a connection over the network between the client application to a second socket specified in the routing table, applying SSL (secured socket layer) protocol to the connection, and routing data through the connection.

### CROSS REFERENCE TO RELATED APPLICATIONS

This application claims the benefit of U.S. Provisional Application No. 60/471,041, filed May 9, 2003, and incorporated herein by this reference.

### REFERENCE TO COMPUTER PROGRAM LISTING APPENDIX SUBMITTED ON A COMPACT DISK

Appendix A contains the following file in one CD-ROM (of which two identical copies are attached hereto), and are a part of the present disclosure and are incorporated by reference herein in their entirety.

Volume in drive D is 040507_{—}0916

Volume Serial Number is D149-32C7

Directory of D:\

| | |
|---|---|
| 05/06/2004 04:59 p | 24,477 Code.txt |
| 1 File(s) | 24,477 bytes |
| 0 Dir(s) | 0 bytes free |

The above files contain source code for a computer program written in the JAVA language for one embodiment of the invention.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

This invention relates to a method for connecting a client application on a client device to a server application on a server device over a network.

### DESCRIPTION OF RELATED ART

Today's networks, for example the Enterprise Network, consist of a variety of legacy, proprietary, front-end, back-end, and web applications using disparate communication protocols. This makes it difficult to capitalize on the ubiquity and the economics of the Internet to connect business partners, customers, suppliers and individuals without jeopardizing security, and/or degrading application performance and/or increasing operating expenses.

Today's attempts to meet these challenges include application web enabling, the use of virtual private networks (VPNs) and extranets. However, these expedients require an application to be customized or reconfigured to function in such environments and introduce additional network security risks and new costs involved in network management. With current “extranet” and VPN technologies, access to applications and data results in access to the entire network.

### SUMMARY

In one embodiment of the invention, a method to send data from a client application on a client device to a server application on a server device over a network includes listening for an outgoing request from the client application to a first socket in the client device. The method further includes, in response to hearing the outgoing request, establishing a connection over the network between the client application to a second socket specified in the routing table, applying SSL (secured socket layer) protocol to the connection, and routing data through the connection.

In one embodiment of the invention, a method for connecting a client application on a client device and a server application over a network includes listening at a first socket in a server device. The method further includes, in response to hearing an incoming request from the client application, retrieving a routing table based on the first socket, retrieving a routing rule from the routing table based on a signature of the client application in the incoming request, establishing a connection over the network between the server device at the first socket and the client application, applying SSL protocol to the connection, and routing data through the connection.

### BRIEF DESCRIPTION OF THE DRAWINGS

FIG. 1 illustrates a traditional VPN.

FIG. 2 illustrates an SGR extended private network (EPN) in one embodiment of the invention.

FIG. 3 illustrates another traditional VPN.

FIGS. 4 and 5 illustrate SGR EPNs in embodiments of the invention.

FIG. 6 illustrates an SGR client application in one embodiment of the invention.

FIG. 7 illustrates a method for the SGR client application to establish a connection with a destination socket in one embodiment of the invention.

FIG. 8 illustrates an SGR server application in one embodiment of the invention.

FIG. 9 illustrates a method for the SGR server application to establish a connection with an incoming socket in one embodiment of the invention.

FIGS. 10 and 11 illustrate a routing table in embodiments of the invention.

Use of the same reference numbers in different figures indicates similar or identical elements.

### DETAILED DESCRIPTION

In one embodiment of the invention, a software suite only extends server applications on demand, rather than the whole network or portions of the network, so that the sever applications can be individually routed across public and private networks. This software suite is referred to herein as Secure Global Relay (“SGR”). SGR opens an encrypted bi-directional “pipe” in the Application Layer, and can pass application information between client computers and server computers without exposing low-level network layers. Application routing, transport, and management preferably take place exclusively in the Application Layer without involving the Network Layer. Furthermore, SGR permits client applications and server applications to communicate over a wide variety of transmission protocols (e.g., TCP/IP), with no protocol translations necessary. In many cases, this allows even the most mission-critical applications to be connected across unknown topographies without jeopardizing enterprise network.

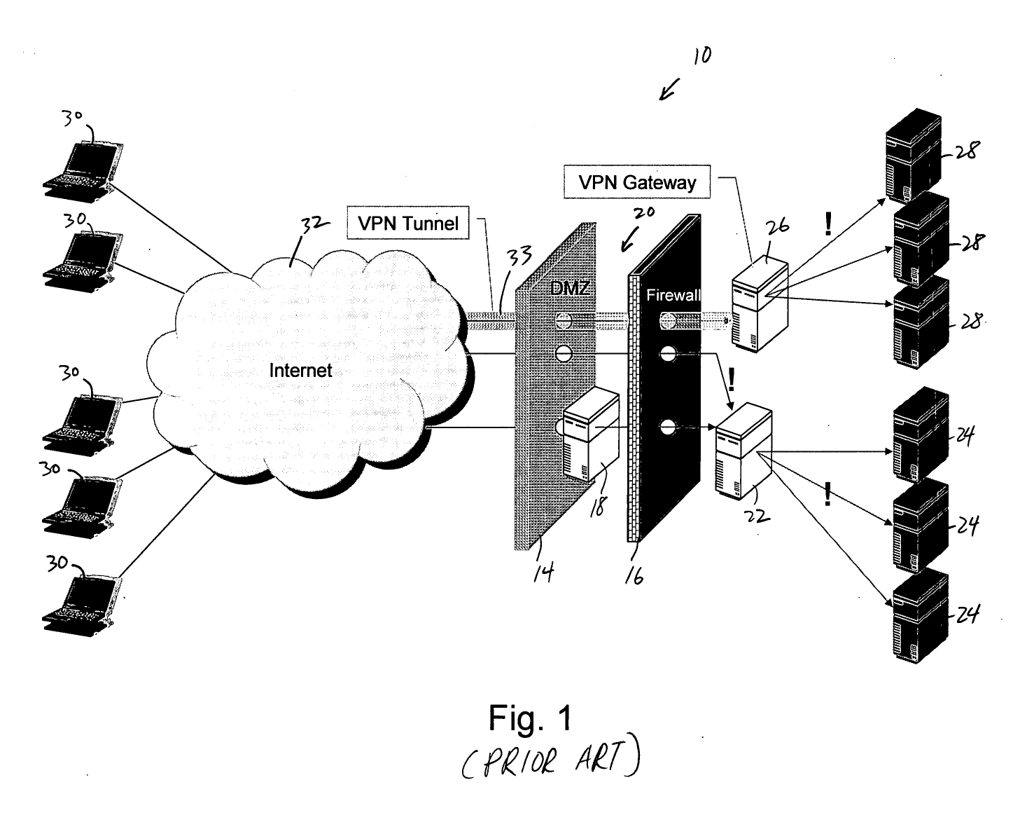

FIG. 1 illustrates a traditional VPN 10. A corporate network 12 includes a firewall 14 and a firewall 16. A web server computer 18 is situated in the DMZ (demilitarized zone) 20 between firewalls 14 and 16. Web server computer 18 is connected through an open port in firewall 16 to an application server computer 22, which is further connected to application server computers 24. Behind firewall 18 sits a VPN gateway 26 that permits access to application server computers 28.

Client computers 30 can connect via a private or public network 32 (e.g., the Internet) to corporate network 12. Once configured, a client computer 30 can connect via a VPN tunnel 33 through firewalls 14 and 16 to VPN gateway 26. Once dropped off at VPN gateway 26, access to the entire corporate network is available to client computer 30. Furthermore, open ports in firewall 16 leave the corporate network susceptible to attack.

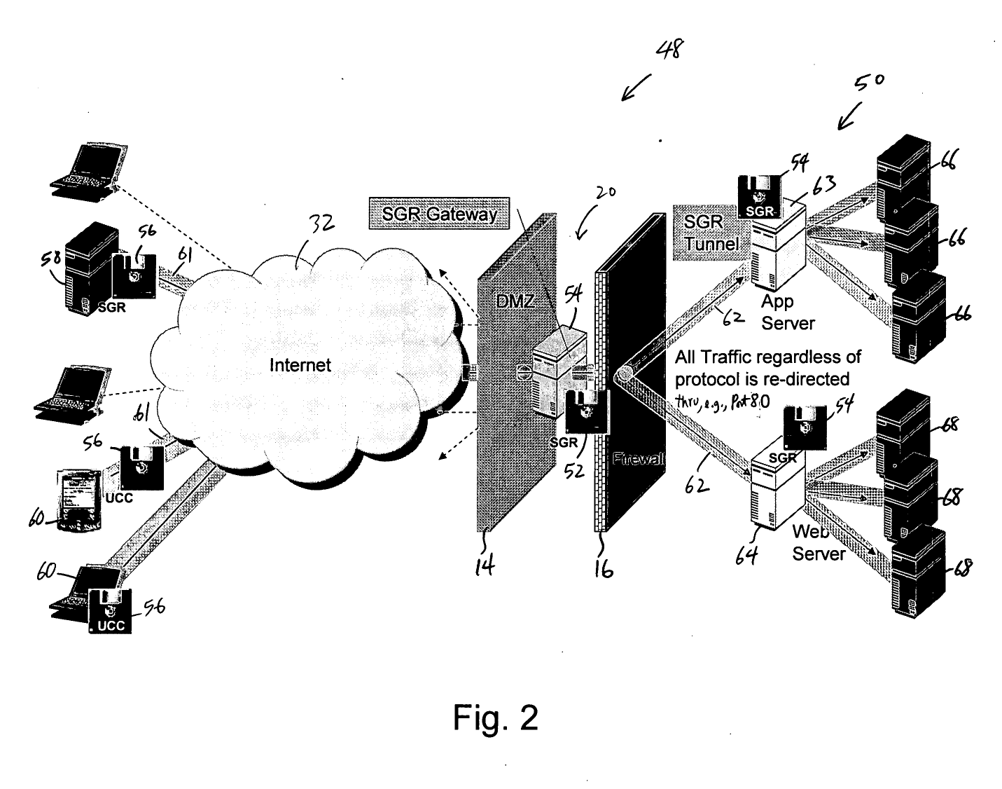

FIG. 2 illustrates an SGR extended private network (EPN) 48 in one embodiment of the invention. In a corporate network 50, SGR server software 52 has been installed on a web server computer 54 (hereafter “SGR gateway”) situated in DMZ 20. SGR client software 56 has been installed on a client computer 58 and thin clients 60. Exemplary thin clients include personal computers, laptops, PDAs (personal digital assistants), cell phones, and any other device with minimal hardware designed to connect to a network. Using the SGR software, client computer 58 and thin clients 60 can establish SGR tunnels 61 through firewall 14 to SGR gateway 54. SGR tunnels 61 are controlled and secured routes between client and server applications or between applications. Likewise, SGR gateway 54 can establish SGR tunnels 62 through firewall 16 to an SGR enabled application server computer 62 and an SGR enabled web server computer 64, which then route data to corresponding application server computers 66 and 68. Although SGR tunnels 62 are typically established through port 80 because that is typically an open port on corporate firewall 16, any port between the SGR client and server software.

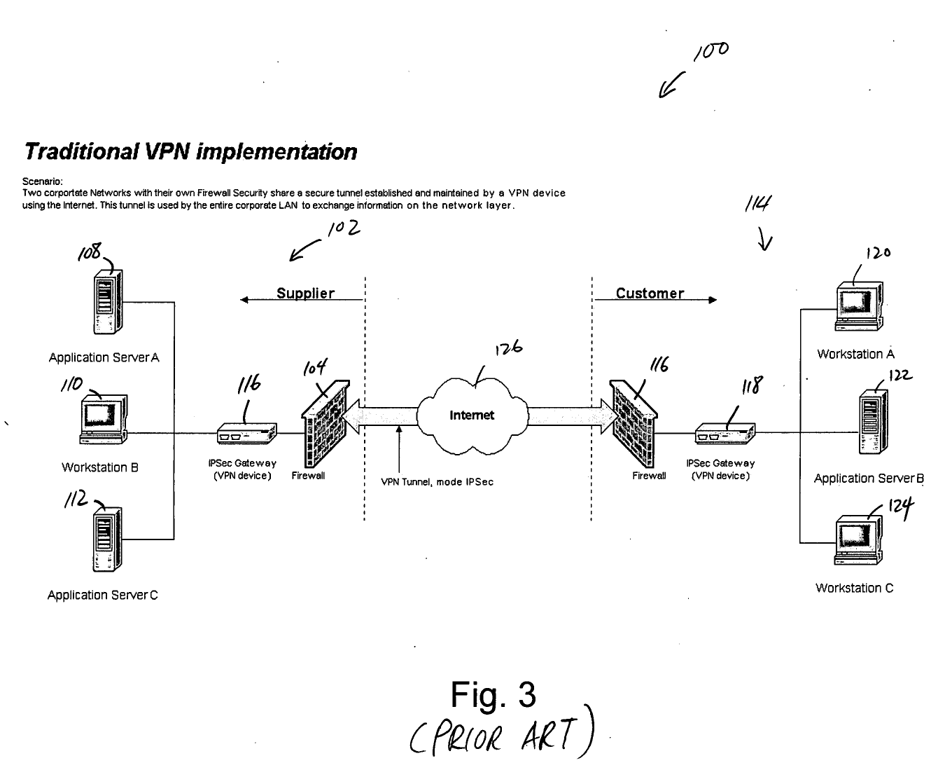

FIG. 3 illustrates another traditional VPN 100. A supplier's network 102 is protected behind a firewall 104. A VPN gateway 106 provides access to a server computer 108, a workstation 110, and a server computer 112. Similarly, a customer's network 114 is protected behind a firewall 116 and a VPN gateway 118 provides access to a workstation 120, a server computer 122, and a workstation 124. A secured VPN tunnel 125 can be established and maintained through a network 126 (e.g., the Internet) between VPN gateways 106 and 118 so that the networks 102 and 114 can exchange information.

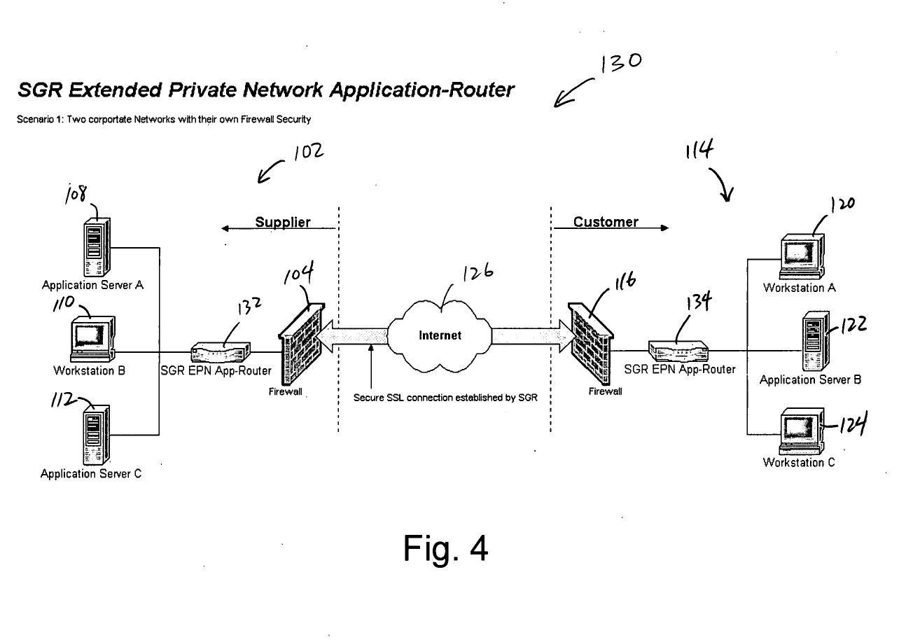

FIG. 4 illustrates an SGR EPN 130 in another embodiment of the invention. EPN 130 is similar to VPN 100 except that VPN gateways 106 and 116 have been replaced by corresponding SGR EPN application-routers 132 and 134. Depending on the embodiment, application-router 132 and 134 can be implemented with dedicated hardware or SGR server software installed on server computers. Application-routers 132 and 134 establish a SGR tunnel between networks 102 and 114.

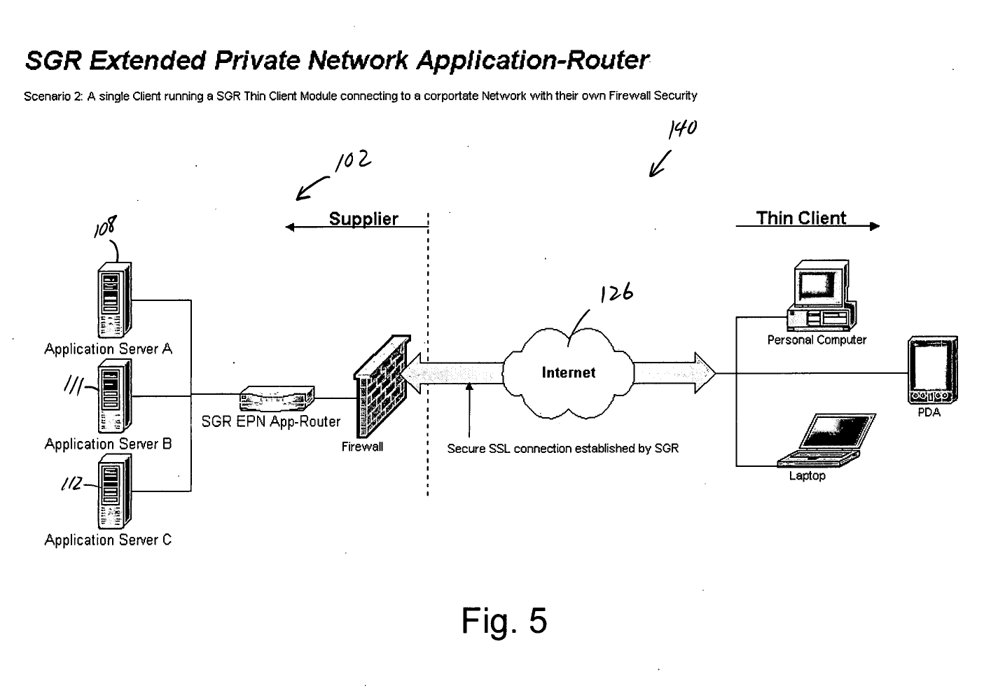

FIG. 5 illustrates an SGR extended private network (EPN) 140 in another embodiment of the invention. EPN 140 is similar to EPN 130 except that SGR client software has been installed on thin clients 142, 144, and 146 so they can establish SGR tunnel 125 to corporate network 102 to access server computers 108, 111, and 112.

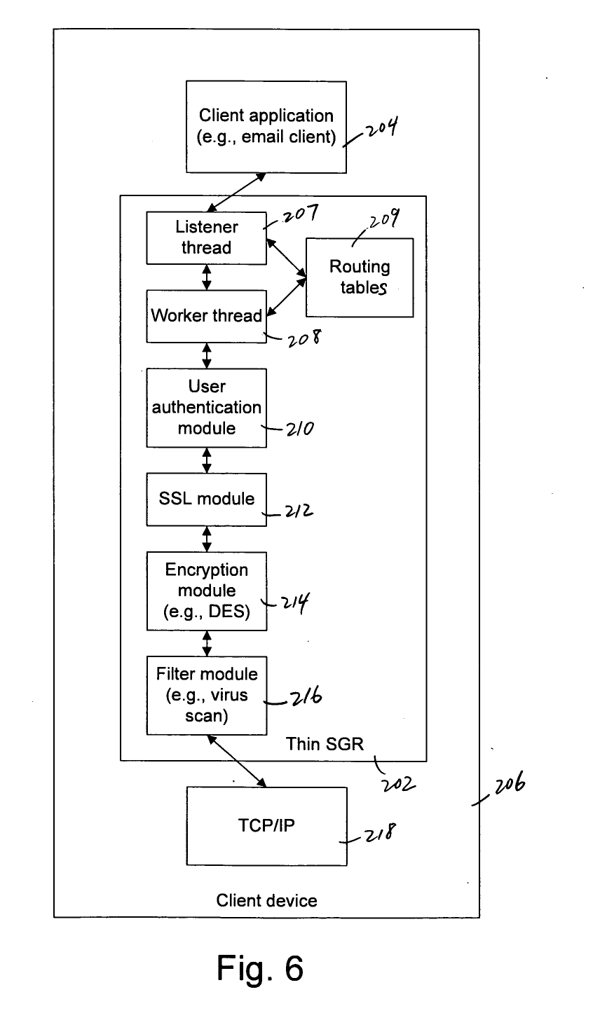

FIG. 6 illustrates the software architecture of an SGR client software 202 that enables one or more client applications 204 (e.g., an email client) on a client device 206 to exchange information with one or more application servers on one or more server devices in one embodiment of the invention. Although only one client application 204 is shown, multiple client applications can run on client device 206. In one embodiment, SGR client software 202 is implemented in the computer language of JAVA.

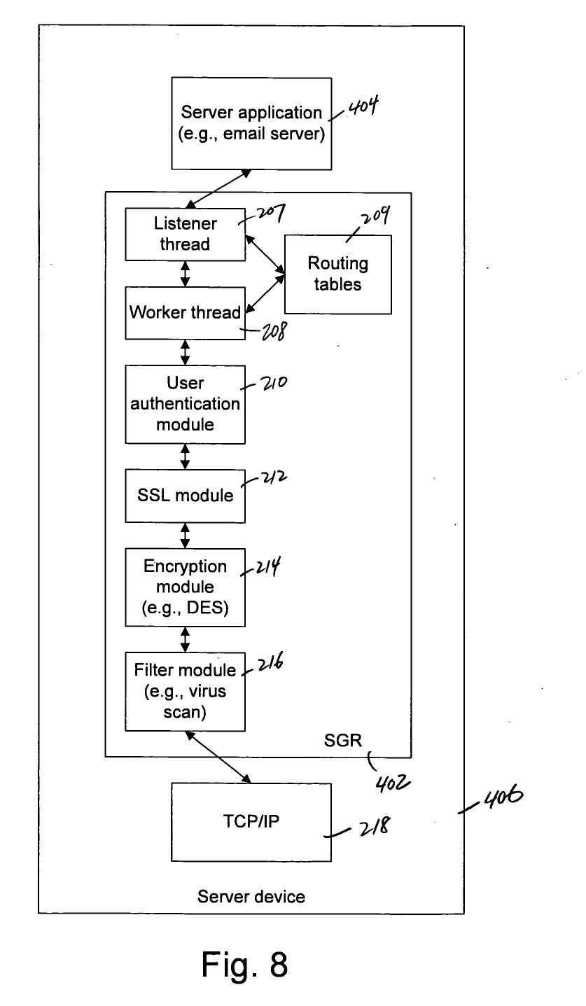

SGR client software 202 spawns a listener thread 207 to listen for requests to exchange data between one or more incoming sockets (e.g., one or more client applications 202) and one or more destination sockets (e.g., one or more server applications 402 in FIG. 8). In response, listener thread 207 spawns worker threads 208 to establish connections between incoming and destination sockets. To determine where and how to establish these connections, worker threads 208 look up routing rules in routing tables 209. In SGR client software 202, each routing table contains only one routing rule. This is because each routing rule is specific to one client application, and each routing table is specific to one incoming socket used by only one client application. The routing rule provides a destination socket including a network address, such as an IP (internet protocol) address or a FQDN (fully qualified domain name) address, and a port number for the connection. The routing rule also provides various parameters for the connection. For example, the routing rule may require a worker thread 208 to (1) authenticate the incoming socket using a user authentication module 210, (2) wrap the connection to the destination socket using an SSL module 212, (3) encrypt outgoing data to the destination socket and decrypt incoming data from the destination socket using an encryption module 214 (e.g., using an industry standard 128-bit encryption algorithm), and (4) filter outgoing data to the destination socket and incoming data from the destination socket using a filter module 216. A transmission protocol 218 performs the data transport from an incoming socket and to the destination socket over the network. Exemplary transmission protocols include TCP/IP, UDP, and FTP.

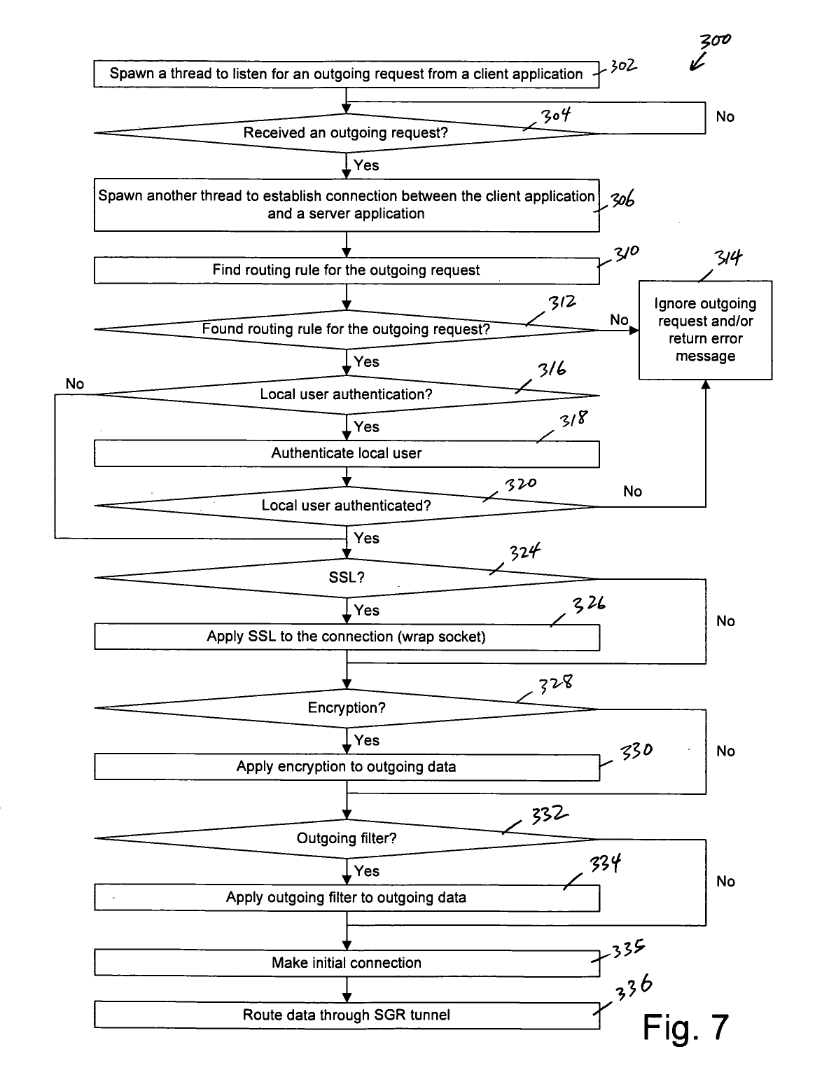

FIG. 7 illustrates a method 300 by SGR client software 202 (FIG. 6) to enable one or more client applications 204 (FIG. 6) on client device 206 (FIG. 6) to send data to one or more server applications 402 (FIG. 8) on one or more server devices 406 (FIG. 8) in one embodiment of the invention.

In step 302, SGR client software 202 spawns a listener thread 207 (FIG. 6) to listen at an incoming socket having a particular IP address and a particular port number specified by a routing table 209 (FIG. 6). As each socket is only used by one client application, routing table 209 only contains one routing rule specific to one client application. In other words, listener thread 207 is listening for a request from one specific client application 204. Of course, multiple listener threads may be spawned to listen for requests from multiple client applications. Step 302 is followed by step 304.

In step 304, listener thread 207 determines if it has heard a request to the specific incoming socket. If so, step 304 is followed by step 306. Otherwise step 304 loops until listening thread 207 hears a request to the specific incoming socket.

In step 306, listener thread 207 spawns a worker thread 208 (FIG. 6) to establish a connection between the incoming socket (e.g., client application 204) and a destination socket (e.g., server application 404). For listener thread 207, step 306 is followed by step 304. For worker thread 208, step 306 is followed by step 310.

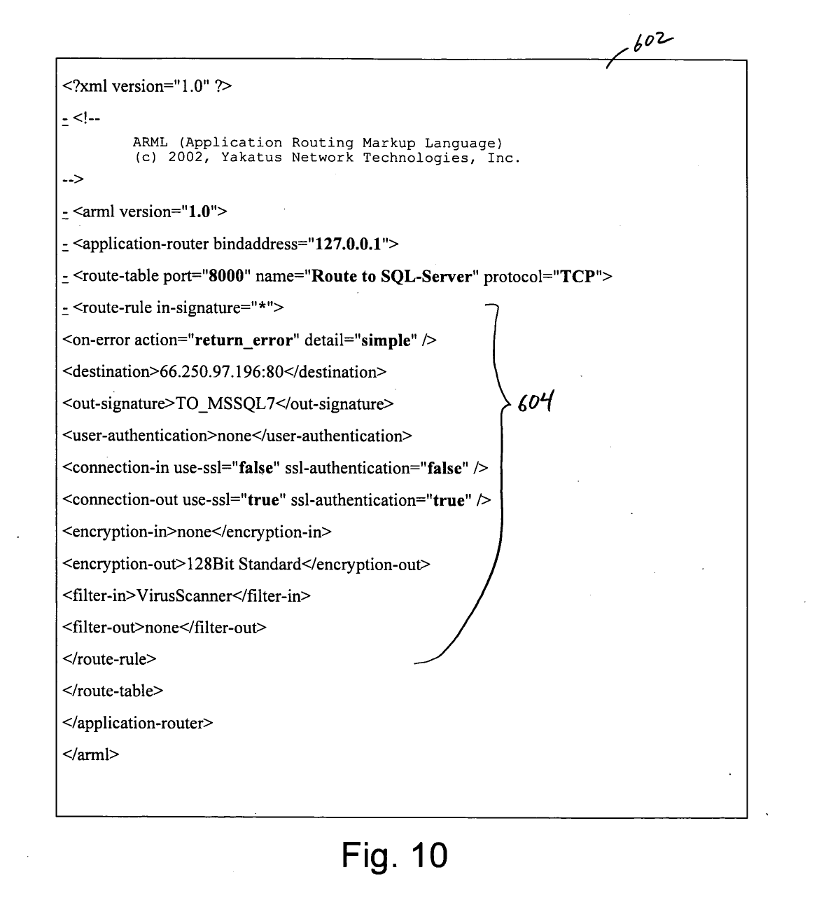

In step 310, worker thread 208 looks for a routing rule in a routing table for the specific incoming socket. As described above, in SGR client software 202, a routing table is specific to an incoming socket and contains a routing rule specific to a client application. FIG. 10 illustrates an exemplary routing table 602 specific to an incoming socket having an IP address of “127.0.0.1” and a port of “8000.” Routing table has a name of “Route to SQL-Server” and requires the use of a transport protocol of “TCP.” Routing table contains a routing rule 604 specific to an incoming signature of “*” in the header of the request sent to the incoming socket. “*” is a wildcard so that routing rule 604 accepts all requests sent to the incoming socket. Routing rule 604 has a destination socket of “66.250.97.196:80” and an outgoing signature “TO_MSSQL7” in the header of a request to the destination socket. For the incoming data from the incoming socket, routing rule 604 requires no user authentication, no SSL, no SSL authentication, no encryption, and a filter of “VirusScanner.” For the outgoing data to the destination socket, routing rule 604 requires routing rule 604 requires SSL, SSL authentication, encryption of “128 Bit Standard,” and no filter. Step 310 is followed by step 312.

In step 312, worker thread 208 determines if it has found the routing rule specific to the outgoing request. If so, step 312 is followed by step 318. Otherwise step 312 is followed by step 314.

In step 314, worker thread 208 ignores the request at the incoming socket and/or returns an error message to the incoming socket. Worker thread 208 then terminates.

In step 316, worker thread 208 determines whether or not the routing rule requires authentication of the incoming socket. If so, step 316 is followed by step 318. Otherwise step 316 is followed by step 324.

In step 318, worker thread 208 uses user authentication module 210 to authenticate the user on the client application. For example, authentication module 210 can maintain a simple user database with login names and passwords or connect to an existing user authentication mechanism such as a SQL (structure query language) database or an LDAP (lightweight directory access protocol). Authentication module 210 can then check a login name and a password included in the request to the incoming socket. Step 318 is followed by step 320.

In step 320, worker thread 208 determines if the user of the application client has been authenticated. If so, then step 320 is followed by step 324. Otherwise step 320 is followed by step 314 described above.

In step 324, worker thread 208 determines whether or not the routing rule requires the connection to the destination socket to be warped in SSL. If so, then step 324 is followed by step 326. Otherwise step 324 is followed by step 328.

In step 326, worker thread 208 uses SSL module 212 to wrap the connection to the destination socket in SSL. SSL module 212 establishes a conventional SSL connection that wraps the outgoing data in SSL. Step 326 is followed by step 328.

In step 328, worker thread 208 determines whether or not the routing rule requires encryption of the outgoing data to the destination socket through the connection. If so, step 328 is followed by step 330. Otherwise step 328 is followed bys step 332.

In step 330, worker thread 208 activates encryption module 214 to encrypt any outgoing data to the destination socket. Step 330 is followed by step 332.

In step 332, worker thread 208 determines whether or not the routing rule requires filtering of the outgoing data to the destination socket through the connection. If so, step 332 is followed by step 334. Otherwise step 332 is followed bys step 336.

In step 334, worker thread 208 activates filter module 216 to filter any outgoing data to the destination socket. In one embodiment, filter module 216 can scan the data for virus, spam, or indecent materials. Step 334 is followed by step 335.

In step 335, worker thread 208 establishes an initial connection to the destination socket using transmission protocol 218. Specifically, worker thread 208 sends a request to the destination socket so the SGR server software on the other end can prepare for the connection. Typically, the request has a header including an SGR signature and a connection signature separated by a pipe sign and terminated by a semicolon (e.g., “SGR_{—}2.1|TO_YAKATUS;”). Step 325 is followed by step 336.

In step 336, worker thread 208 routes the data between the incoming socket and the destination socket through the established bidirectional connection. Note that worker thread 208 may have to unwrap, decrypt, and/or filter the data received from server application 402 through the established bidirectional connection.

FIG. 8 illustrates the software architecture of SGR server software 402 that enables one or more server applications 404 on a server device 406 to exchange data with one or more client applications on one or more server devices in one embodiment of the invention. As can be seen, SGR server software 402 has the same modules as SGR client software 202 except that it serves server applications 404 instead of client applications 204 and that routing tables 209 may each have multiple routing rules. In one embodiment, SGR sever software 402 is implemented in the computer language of JAVA.

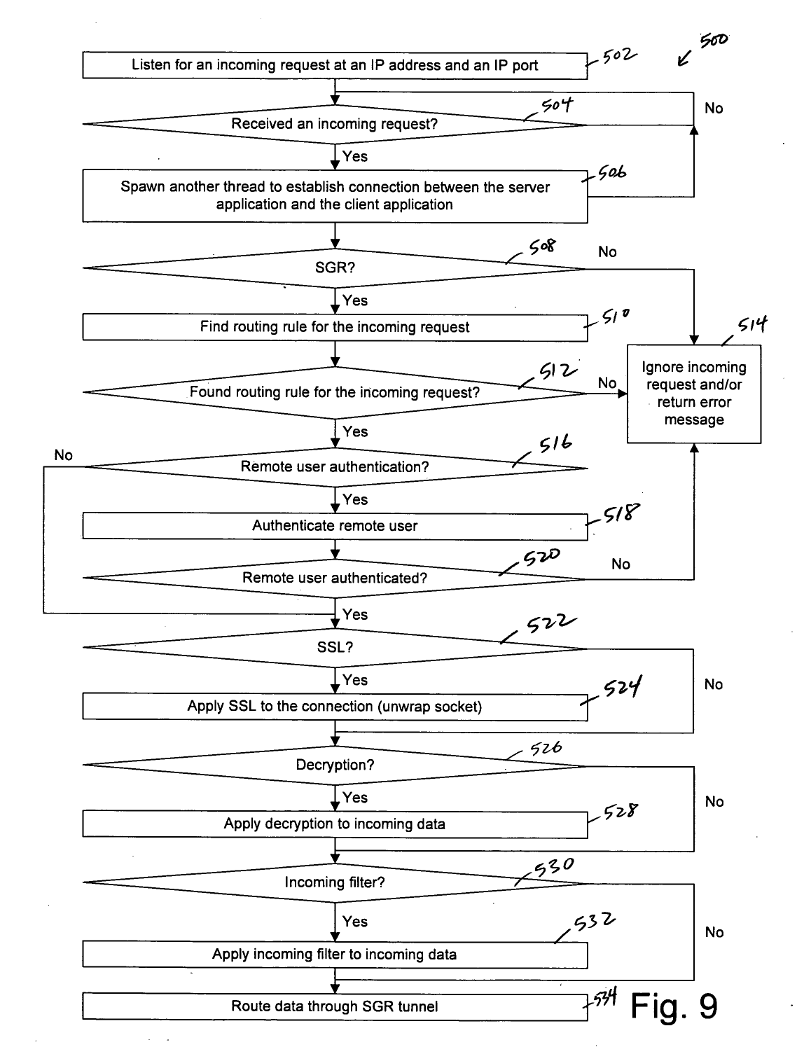

FIG. 9 illustrates a method 500 by SGR server software 402 (FIG. 8) to enable one or more server application 404 on server device 406 to receive data from one or more application clients 204 on one or more client devices 206 in one embodiment of the invention.

In step 502, SGR server software 402 spawns a listener thread 207 to listen at an incoming socket having a particular IP address and a particular port number specified by a routing table 209. As each socket can be used by multiple client applications to communicate with server application 404, routing table 209 may contain multiple routing rules specific to each client application. In other words, listener thread 207 is listening for any request from any client application sent to a specific incoming socket. Of course, multiple listener threads may be spawned to listen for requests from multiple incoming sockets. Step 502 is followed by step 504.

In step 504, listener thread 207 determines if it has heard a request to the specific incoming socket. If so, step 504 is followed by step 506. Otherwise step 504 loops until listening thread 207 hears a request to the specific incoming socket.

In step 506, listener thread 207 spawns a worker thread 208 to establish a connection to the incoming socket. For listener thread 207, step 506 is followed by step 504. For worker thread 208, step 506 is followed by step 508.

In step 508, worker thread 208 determines if the request is for an SGR connection. If so, step 508 is followed by step 510. Otherwise step 508 is followed by step 514. As described above in step 335, a request for an SGR connection includes a header having an SGR signature.

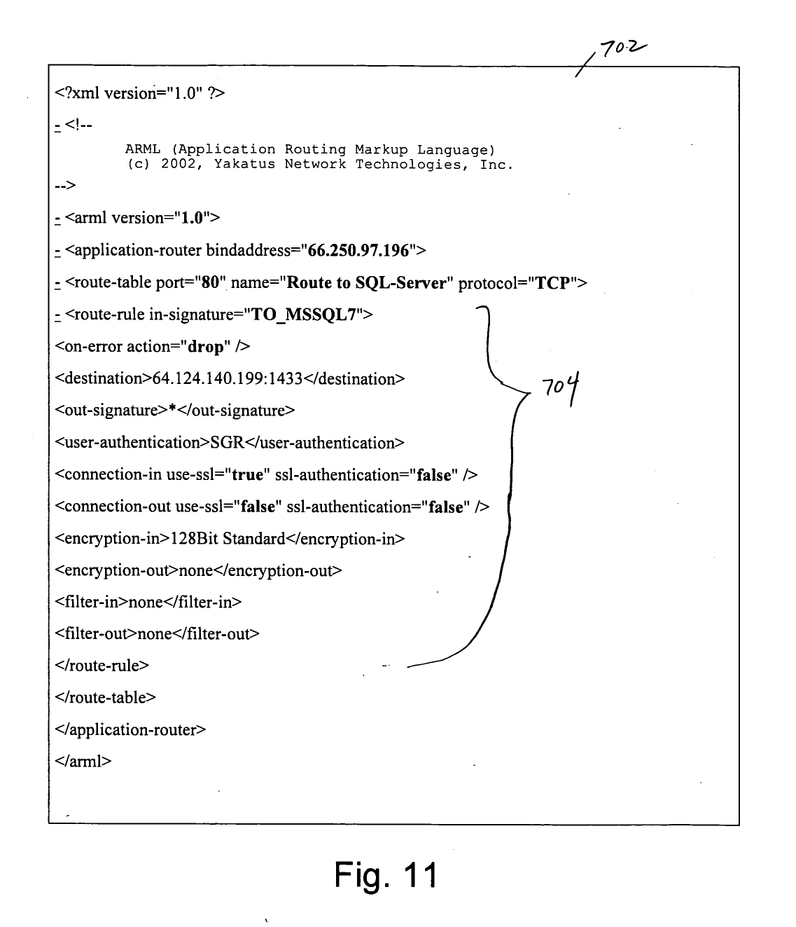

In step 510, worker thread 208 looks for a routing rule from a routing table that is specific to the incoming socket. As described above, the routing table is specific to an incoming socket, and the routing rule is specific to a client application. FIG. 11 illustrates an exemplary routing table 702 specific to a socket having an IP address of “66.250.97.196” and a port of “80.” Routing table 702 has a name of “Route to SQL-Server” and requires the use of a transport protocol of “TCP.” Routing table 702 contains a routing rule 704 specific to an incoming signature of “TO_MSSQL7” in the header of the request sent to the incoming socket. Routing rule 704 has a destination socket of “64.124.140.199:1433” and an outgoing signature of “*,” which again is a wildcard. For the incoming data from the incoming socket, routing rule 704 specifies user authentication, SSL, no SSL authentication, decryption, and no filter. For the outgoing data to the destination socket, routing rule 704 specifies no SSL, no SSL authentication, no encryption, and no filter. Step 510 is followed by step 512.

In step 512, worker thread 208 determines if it has found the routing rule specific to the outgoing request. If so, step 512 is followed by step 518. Otherwise step 512 is followed by step 514.

In step 514, worker thread 208 ignores the outgoing request and/or returns an error message to the incoming socket. Worker thread 208 then terminates.

In step 516, worker thread 208 determines whether or not the routing rule requires authentication of the incoming socket. If so, step 516 is followed by step 518. Otherwise step 516 is followed by step 522.

In step 518, worker thread 208 uses user authentication module 210 to authenticate the user on the client application. For example, authentication module 210 can maintain a simple user database with login names and passwords or connect to an existing user authentication mechanism such as a SQL (structure query language) database or an LDAP (lightweight directory access protocol). Authentication module 210 can then check a login name and a password included in the header of the SGR request. Step 518 is followed by step 520.

In step 520, worker thread 208 determines if the user of the client application has been authenticated. If so, then step 520 is followed by step 522. Otherwise step 520 is followed by step 514 described above.

In step 522, worker thread 208 determines whether or not the routing rule requires the connection from the incoming socket to be warped in SSL. If so, then step 524 is followed by step 526. Otherwise step 524 is followed by step 528.

In step 524, worker thread 208 uses SSL module 212 to unwrap the connection from incoming socket. SSL module 212 establishes a conventional SSL connection that unwraps the incoming data from SSL. Step 526 is followed by step 528.

In step 526, worker thread 208 determines whether or not the routing rule requires decryption of the incoming data from the incoming socket. If so, step 526 is followed by step 528. Otherwise step 526 is followed bys step 530.

In step 528, worker thread 208 uses encryption module 214 to decrypt the incoming data from the incoming socket. Step 528 is followed by step 530.

In step 530, worker thread 208 determines whether or not the routing rule requires filtering of the incoming data from the incoming socket. If so, step 530 is followed by step 532. Otherwise step 530 is followed bys step 534.

In step 532, worker thread 208 uses filter module 216 to filter the incoming data from the incoming socket. In one embodiment, filter module 216 can scan the data for virus, spam, or indecent material. Step 532 is followed by step 534.

In step 534, worker thread 208 routes the data to and from the incoming socket through the established bilateral connection.

Worker thread 208 will also need to route the data between the incoming socket and the destination socket specified in the routing rule. To do so, SGR server software 402 can take steps similar to steps 316 to 336 described above in method 300 to establish another SGR connection. In one embodiment, the destination socket is local to server device 406 and server application 404 simply picks up the data at the destination socket from SGR server software 402. In such an embodiment, the data need not to be wrapped in SSL, encrypted, and/or filtered. In another embodiment, the destination socket is at another server device and another SGR connection will need to be established.

As described above, SGR may be protocol agnostic because it uses the underlying TCP/IP layer to transport data. Data is routed on the packet layer; the actual content of the data packet is of no consideration for the transport. Therefore, SGR can route any type of data/protocol that uses TCP/IP. SGR itself does not, by default, add any additional information to the routed data. SGR does not require any routed data to be altered, which allows it to route data independent from the higher-level protocol. This also allows SGR to maintain a full duplex, “always on” connection that does not have any of the restrictions of higher-level protocols, such the request/response based HTTP.

SGR intensively utilizes JAVA's ability to spawn class-files as stand-alone “threads.” Every incoming connection spawns its own thread that gets as much CPU attention as possible (only restricted by the physical memory installed on the client or server device). This gives SGR the ability to fully use the potential of the computer it runs on. This method makes it highly scaleable as well as highly reliable because even if a routing thread would error out for some reason, none of the other running threads would be affected. In a single-thread application, an error anywhere in the application would be fatal for the whole application.

By using JAVA as a programming language, SGR is platform independent. The ability to run on any platform that supports JAVA (including wireless devices), adds greatly to the versatility of SGR.

SGR has a unique set of security features including: (1) industry standard SSL to secure the channel used for transporting the data (optional); (2) industry standard 128 bit encryption for the data (optional); (3) customizable digital signatures for individual routing connections, enabling SGR routed traffic to hide “within” existing traffic on any given port (by default Port 80 is used to hide within regular HTTP traffic); (4) additional user authentication that provides additional security to applications that do not provide build-in user authentication.

SGR has a modular architecture. This allows the replacement of any functionality within SGR at runtime. For example, the standard 128-bit encryption algorithm can be switched with a different encryption module without having to stop and restart the SGR enabled client and server. The same is true for the SSL module and many others. This allows for an enterprise wide update of components and makes for very easy deployment of updates. Because SGR is “bi-directional,” a central SGR server can “push” updates to other SGR servers or SGR thin clients.

Various other adaptations and combinations of features of the embodiments disclosed are within the scope of the invention. Numerous embodiments are encompassed by the following claims.

1. A method for connecting a client application on a client device and a server application on a server device over a network, comprising:
listening at first socket in the client device;
in response to hearing an outgoing request from the client application at the first socket,
retrieving a routing table based on the first socket;
establishing a connection over the network between the first socket and a second socket specified in a routing rule in the routing table;
applying SSL (secured socket layer) protocol to the connection; and
routing data through the connection to the second socket.

2. The method of claim 1, wherein said listening is performed by a first thread, which, in response to hearing the outgoing request, starts a second thread to perform said retrieving a routing table, said retrieving a routing rule, said establishing a connection, said applying SSL protocol to the connection, and said routing data.

3. The method of claim 1, wherein said establishing a connection comprising sending to the second socket a signature of the method and the signature of the client application.

4. The method of claim 1, wherein the first socket and the second socket each includes a network address and a port number, the network address being selected from the group of IP (internet protocol) address and a FQDN (fully qualified domain name).

5. The method of claim 1, wherein the connection comprises a transport protocol specified by the routing rule, the transport protocol being selected from the group consisting of TCP/IP, UDP, and FTP.

6. The method of claim 1, wherein said applying SSL to the connection comprises wrapping the second socket.

7. The method of claim 1, after said retrieving a routing rule, further comprising, authenticating a user of the client application.

8. The method of claim 7, after said retrieving a routing rule, further comprising applying an outgoing encryption algorithm specified by the routing rule to the data.

9. The method of claim 8, after said retrieving a routing rule, further comprising applying an outgoing filter specified by the routing rule to the data.

10. The method of claim 9, wherein said listening is performed by a first thread, which, in response to hearing the outgoing request, starts a second thread to perform said retrieving a routing table, said retrieving a routing rule, said authenticating a user, said establishing a connection, said applying SSL protocol to the connection, said applying an encryption algorithm, said applying an outgoing filter, and said routing data

11. A method for connecting a client application on a client device and a server application over a network, comprising:
listening at a first socket in a server device;
in response to hearing an incoming request from the client application,
retrieving a routing table based on the first socket;
retrieving a routing rule from the routing table based on a signature of the client application in the incoming request;
establishing a connection over the network between the server device at the first socket and the client device;
applying SSL (secured socket layer) protocol to the connection; and
routing data through the connection.

12. The method of claim 11, wherein said listening is performed by a first thread, which, in response to hearing the incoming request, starts a second thread to perform said retrieving a routing table, said retrieving a routing rule, said establishing a connection, said applying SSL protocol to the connection, said routing data, and said providing the data.

13. The method of claim 1 1, wherein said incoming request includes a signature of the method and the signature of the client application.

14. The method of claim 11, wherein the first socket and the second socket each includes a network address and a port number, the network address being selected from the group of IP (internet protocol) address and a FQDN (fully qualified domain name).

15. The method of claim 11, wherein the connection comprises a transport protocol specified by the routing rule, the transport protocol being selected from the group consisting of TCP/IP, UDP, and FTP.

16. The method of claim 1 1, wherein said applying SSL to the connection comprises unwrapping the first socket.

17. The method of claim 1 1, after said retrieving a routing rule, further comprising, authenticating a user of the client application.

18. The method of claim 17, after said retrieving a routing rule, further comprising applying an incoming decryption algorithm specified by the routing rule to the data.

19. The method of claim 18, after said retrieving a routing rule, further comprising applying an incoming filter specified by the routing rule to the data.

20. The method of claim 19, wherein said listening is performed by a first thread, which, in response to hearing the incoming request, starts a second thread to perform said retrieving a routing table, said retrieving a routing rule, said authenticating a user, said establishing a connection, said applying SSL protocol to the connection, said applying an incoming decryption algorithm, said applying an incoming filter, said routing data, and said providing the data.

21. The method of claim 19, further comprising:
establishing another connection over the network between the first socket and a second socket specified in the routing rule;
routing data through said another connection to the second socket.

22. The method of claim 21, further comprising:
applying SSL (secured socket layer) protocol to said another connection; and

23. The method of claim 21, further comprising applying an outgoing decryption algorithm specified by the routing rule to the data sent to said another connection.

24. The method of claim 21, further comprising applying an outgoing filter specified by the routing rule to the data send to said another connection.

25. A software for providing connecting a client application on a client device and a server application on a server device over a network, comprising:
a first thread for listening to an outgoing request at a first socket in the client device and for starting a second thread in response to receiving an outgoing request from the client application at the first socket;
the second thread for:
retrieving a routing table based on the first socket;
establishing a connection over the network between the client device at the first socket and the server device at a second socket specified in a routing rule in the routing table;
applying SSL (secured socket layer) protocol to the connection; and
routing data through the connection;
the routing table, listing:
the first socket;
the routing rule, listing:
the signature of the outgoing request the second thread processes;
the second socket;
an SSL module for securing to the connection.

26. The software of claim 25, further comprising an authentication module for authenticating a user, wherein the routing table further lists a flag to authenticate the data.

27. The software of claim 25, further comprising an encryption module for encrypting the data, wherein the routing table further lists a parameter to encrypt the data.

28. The software of claim 25, further comprising a filter module for filtering the data, wherein the routing table further lists a parameter to filter the data.

29. The software of claim 25, wherein the touting table further lists a transportation protocol for the connection, the transportation protocol being selected from the group consisting of TCP/IP, UDP, and FTP.

30. A software for providing connecting a client application on a client device and a server application over a network, comprising:
a first thread for listening at a first socket in a server device and starting a second thread in response to receiving an incoming request from the client application at the first socket;
the second thread for:
retrieving a routing table based on the first socket;
retrieving a routing rule from the routing table based on a signature of the client application;
establishing a connection over the network between the server device at the first socket and the client device;
applying SSL (secured socket layer) protocol to the connection; and
routing data through the connection;
the routing table, listing:
the first socket;
the routing rule, listing:
the signature of the incoming request the second thread processes;
the second socket;
an SSL module for securing to the connection.

31. The software of claim 30, further comprising an authentication module for authenticating a user, wherein the routing table further lists a parameter to authenticate the data.

32. The software of claim 30, further comprising an encryption module for encrypting and decrypting the data, wherein the routing table further lists a first parameter to encrypt the data and a second first parameter to decrypt the data

33. The software of claim 30, further comprising a filter module for filtering the data, wherein the routing table further lists a parameter to filter the data.

34. The software of claim 30, wherein the routing table further lists a transportation protocol for the connection, the transportation protocol being selected from the group consisting of TCP/IP, UDP, and FTP.

35. The software of claim 30, wherein the second thread further:
establishing another connection over the network between the first socket and a second socket specified in the routing rule;
routing data through said another connection to the second socket.
